(19) United States
(12) Patent Application Publication
(10) Pub. No.: US 2025/0297606 A1
(43) Pub. Date: Sep. 25, 2025

(54) ELECTRICAL MACHINE

(71) Applicants: MAHLE International GmbH, Stuttgart (DE); Mahle Automotive Technologies (Suzhou), Shanghai (CN)

(72) Inventors: Stephan Schild, Brackenheim (DE); Benjamin Weimann, Radolfzell (DE); Stephan Kohlheim, Renningen (DE); Eugen Makarow, Ludwigsburg (DE); Timo Linke, Ostfildern (DE); Maron Badt, Kirchheim a.N. (DE); Wayne Zhou, Changshu (CN); William Zhang, Stuttgart (DE); Chun Li, Stuttgart (DE)

(21) Appl. No.: 19/087,427

(22) Filed: Mar. 21, 2025

(30) Foreign Application Priority Data
Mar. 22, 2024 (CN) 202410338256.7
Sep. 23, 2024 (DE) 102024127426.3

(51) Int. Cl. F04C 2/10; F04D 13/06; H02K 7/08; H02K 9/19; H02K 11/33

(52) U.S. Cl. CPC F04C 2/10; F04D 13/0693; H02K 7/088; H02K 9/19; H02K 11/33; F04C 2240/40; F04C 2240/808; H02K 2211/03

(57) ABSTRACT

An electrical machine is disclosed. The electrical machine includes a rotor rotatable around an axis of rotation and a stator fixed against rotation with respect to the rotor and which concentrically encloses the rotor, forming an annular gap bounded radially between the rotor and the stator and through which a cooling liquid can flow. The stator is at least partially encapsulated by injection molding with a plastic sheathing. A printed circuit board with electronic components arranged on it and a central opening through which a rotor shaft of the rotor protrudes. The plastic sheathing has on a side facing the printed circuit board at least one recess in which at least one electronic component of the printed circuit board engages.

### CROSS-REFERENCE TO RELATED APPLICATIONS

This application claims priority to Chinese Patent Application No. CN 202410338256.7, filed Mar. 22, 2024 and German Patent Application No. DE 102024127426.3, filed on Sep. 23, 2024, the contents both of which are hereby incorporated by reference in their entirety.

### TECHNICAL FIELD

The present invention relates to an electrical machine.

### BACKGROUND

Electrical machines, in particular pumps for use in motor vehicles, are already familiar in many forms. These are often liquid-cooled due to the high power required. In order to meet the increasing demand for performance, larger and larger electronic components are required, which have to be arranged in a space that is not necessarily getting larger, since the space available in a motor vehicle is limited.

### SUMMARY

The present invention is therefore concerned with the problem of specifying an electrical machine that is particularly powerful and at the same time compact.

According to the invention, this problem is solved by the object of the independent claim(s). Advantageous embodiments are the subject of the dependent claims.

The present invention is based on the general idea of designing the end face of a plastic sheathing of a stator of an electrical machine in such a way that a space for electronic components of a printed circuit board can be provided in it at the same time. This makes it possible for the first time to arrange an electrical printed circuit board with electronic components arranged on it in a space-optimized way, since the electronic components are at least partially arranged in a plastic sheathing surrounding the stator. The electrical machine according to the invention has a rotor that can be rotated around an axis of rotation and a stator that is fixed in terms of rotation with respect to the rotor, which concentrically surrounds the rotor, forming an annular gap that is confined between the rotor and the stator and through which a cooling liquid can flow. The stator is at least partially molded with a plastic material. Furthermore, a printed circuit board is provided, for example of a control unit, with electronic components arranged on it and a central opening through which a rotor shaft of the rotor and/or the plastic sheathing of the stator protrudes. According to the invention, the plastic sheathing has at least one recess on the side facing the printed circuit board, in which at least one electronic component of the printed circuit board engages. This makes it possible to utilize a previously unused space for the arrangement of electronic components on the printed circuit board, resulting in a significantly more compact design. At the same time, the solution according to the invention makes it possible to create a more powerful electrical machine that requires larger electronic components, so that these can provide more power with the same external dimensions due to the arrangement engaging at least partially in the recess on the plastic sheathing.

In another advantageous embodiment of the electrical machine, a bearing, in particular a sleeve bearing, for the rotor is embedded in the plastic sheathing. In the case of electrical machines known to date from the state of the art, a bearing for a rotor of the electrical machine was often provided as a separately mounted component, which not only increased bearing and logistics costs, but also increased assembly costs. The embedding/injection of the bearing into the plastic sheathing in the present embodiment makes it possible to hold it reliably until the rotor is mounted and at the same time to fix it reliably with respect to the stator without the need for a separate and thus more complex assembly process. Embedding the bearing in the plastic sheathing also eliminates the need for precise machining of a bearing seat, i.e., for example of an outer diameter of the bearing, since the plastic sheathing can easily compensate for any tolerances that occur there. This also makes it possible to simplify the assembly process in particular, thus reducing manufacturing and processing costs that would otherwise be incurred by embedding the bearing in the plastic sheathing. Furthermore, the need for fixing agents, which were previously required for separately formed bearings to fix them to the stator, is eliminated. Overall, this also allows for an extremely compact and cost-effective design.

Alternatively, it is also conceivable that the plastic sheathing in a bearing region forms a bearing, in particular a sleeve bearing, for the rotor, i.e., that no separate bearing needs to be provided. This can further simplify the production of the bearing and make it more cost-effective.

It is practical to arrange or design grooves for the coolant on the inner sheathing surface of the bearing. This offers the great advantage that the coolant used to cool the electric motor can simply flow through the slots, such as axial slots, that are already arranged in the bearing. In particular, this eliminates the need for a subsequent and thus time-consuming and expensive process of cutting such slots, which makes the electric motor cheaper to manufacture overall.

In another advantageous embodiment of the electrical machine, electrical connections are embedded in the plastic sheathing for contacting with the printed circuit board. In addition or as an alternative, it is also conceivable that electrical lines are embedded in the plastic sheathing. Embedding electrical connections in the plastic sheathing can help to achieve low assembly tolerances at the interface to the printed circuit board, significantly simplifying the assembly process. This also helps to reduce manufacturing costs. By embedding the electrical connections or lines in the plastic sheathing, they are also extremely well protected, which can ensure a longer service life and increased functional reliability.

In a particularly preferred embodiment of the electrical machine, a space between the recess on the plastic sheathing side and the at least one electronic component, which engages at least partially therein, is filled with a filler, in particular with a potting compound. Filling the space between the recess and the electronic components can, in particular, improve vibration resistance and noise reduction and reduce air volume. This not only increases the service life of the electrical machine according to the invention, but also its smooth running.

In a further advantageous embodiment of the electrical machine according to the invention, at least one flow groove is arranged on an inner sheathing surface of the stator, which is filled with a plastic of the plastic sheathing, whereby the tightness of a wet or dry region in the electrical machine according to the invention can be improved. An annular gap between the rotor and the stator should be kept as small as possible due to a decreasing power of the electrical machine with increasing annular gap thickness, so that the walls of the plastic sheathing on an inner sheathing surface of the stator are preferably designed to be extremely thin. However, spraying thin walls onto large surfaces without prominent weld seams is comparatively difficult and time-consuming. In the preferred embodiment, at least one flow groove arranged on the inner sheathing surface of the stator makes it possible to the molten plastic, for example a polymer, to flow better to the thin walls, whereby the plastic sheathing, in particular on an inner wall facing the rotor, has only a very small wall thickness, so that a small distance between the rotor and the stator can be kept and thus the power of the electrical machine according to the invention can be kept high. Such a flow groove can, for example, run axially, i.e., in the direction of a rotor axis, but also at an angle to it, depending on what is necessary to produce the plastic walls, in particular those that are free of seams.

In a particularly preferred embodiment of the electrical machine, at least one fixing surface that is not encapsulated or covered by the plastic sheathing, that is to say a fixing surface that is free of plastic sheathing, is arranged on an outer sheathing surface of the stator. Since the outer sheathing surface of the stator is not covered by the plastic sheathing at all points, fixing surfaces remain free, via which an extremely precise positioning and fixing in a plastic injection molding tool can be achieved.

In another particularly preferred embodiment, the electrical machine is configured as a positive displacement pump with a gerotor. Positive displacement pumps belong to the category of volumetric pumps, in which media are conveyed by means of moving parts in a closed space. They create a continuous flow of media through physical displacement. These types of positive displacement pumps offer the major advantage of extremely precise delivery and the ability to effectively pump even viscous media without any loss of performance or impairment. In addition, positive displacement pumps usually have a robust design, which means that such positive displacement pumps have a long service life. The major advantage of a positive displacement pump with a gerotor is that it can generate a constant volume flow independently of the system pressure. Furthermore, these types of positive displacement pumps are extremely quiet and require only a small amount of installation space.

Alternatively, the electrical machine can, of course, also be designed as a so-called impeller pump, which has the great advantage that it is dry-self-priming and, in particular, does not need to be filled before use.

The electrical machine according to the invention can be designed as an oil pump, a water pump, or a coolant pump, in particular for use in a motor vehicle, for example an electric vehicle, in accordance with different embodiments. This non-exhaustive list already gives an idea of the many possible uses of the electrical machine according to the invention, although it is of course not limited to the alternatives mentioned above.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral regions or sections of this unit, even if this is shown differently in the drawings.

Preferred embodiments of the invention are shown in the drawings and are explained in more detail in the following description, wherein the same reference signs refer to the same or similar or functionally identical components.

### BRIEF DESCRIPTION OF THE DRAWINGS

The drawings show, each schematically, in

FIG. 1 a section view of an electrical machine according to the invention, designed as an impeller pump,

FIG. 2 a section view through an electrical machine designed as a positive displacement pump according to the invention,

FIG. 3 a section view of an electrical machine according to the invention,

FIG. 4 a view of the plastic sheathing from the front,

FIG. 5 a view of a warehouse,

FIG. 6 a partially transparent view of the electrical machine according to the invention in the region of the electrical cables and connections embedded in the plastic sheathing,

FIG. 7 a view of the inner sheathing surface of a stator with flow grooves,

FIG. 8 a section view through the electrical machine according to the invention,

FIG. 9 an external view of the plastic sheathing with fixing surfaces that are free from plastic sheathing,

FIG. 10 a cross-section view of a possible electronic water pump according to the prior art,

FIG. 11 a cross-section view of an electronic water pump,

FIG. 12 a cross-section view of a stator assembly of an electronic water pump,

FIG. 13 a schematic diagram of a substructure of an electronic water pump at a connection terminal,

FIG. 14 a cross-section view of an electronic water pump rotor assembly.

### DETAILED DESCRIPTION

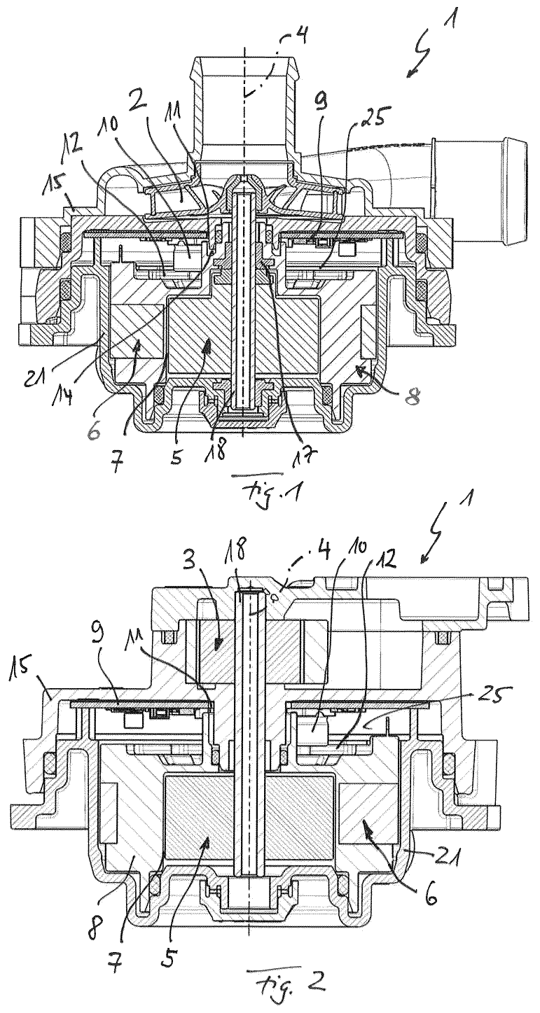

In accordance with FIGS. 1 and 2, an electrical machine 1 according to the invention, which is designed as an impeller pump with an impeller 2 in accordance with FIG. 1 and as a positive displacement pump with a gerotor 3 in accordance with FIG. 2, has a rotor 5 that can rotate around an axis of rotation 4. Also provided is a stator 6 that is fixed in terms of rotation about the axis of rotation 4 and about the rotor 5, concentrically surrounding the rotor 5 while forming an annular gap 7 that is confined between the rotor 5 and the stator 6 and through which a cooling liquid can flow.

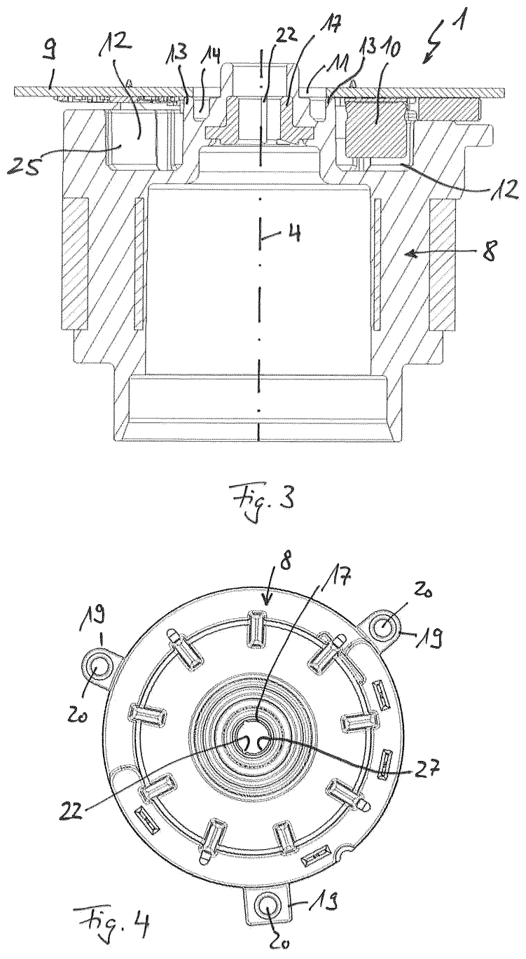

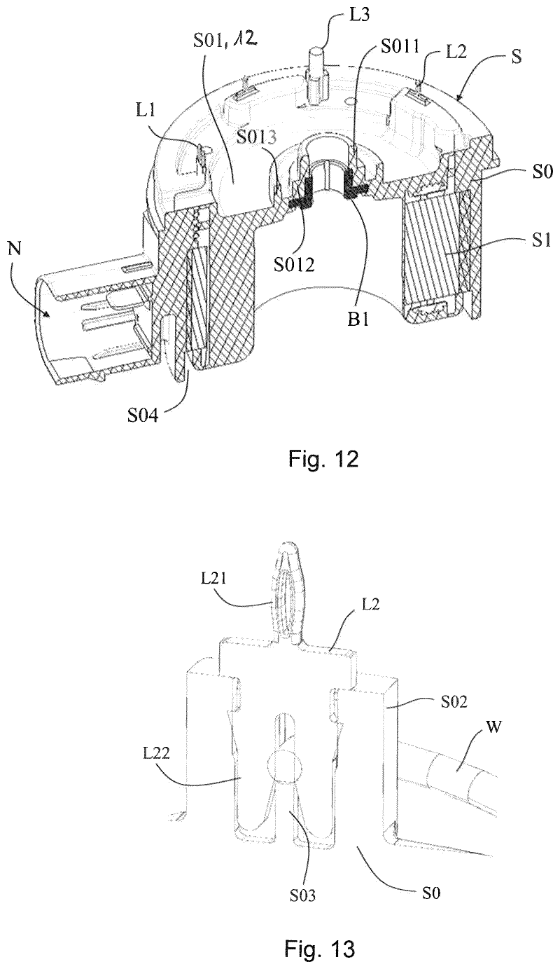

The stator 6 is at least partially encapsulated in a plastic sheathing 8 (see in particular FIGS. 3, 4, 6, 8, and 9). The plastic sheathing 8 is similarly shown and designated as the stator injection molding layer S0 in FIGS. 11 through 13, while the stator 6 is designated in the broadest sense with the reference designation S or S1 in accordance with FIGS. 11 and 12. Furthermore, a printed circuit board 9 is provided with electronic components 10 arranged on it. The printed circuit board 9 has a central opening 11 through which the plastic sheathing 8 of the stator 6 and/or a rotor shaft 18 protrudes. The plastic sheathing 8 has on its side facing the printed circuit board 9 at least one recess 12, in particular an annular recess, in which at least some regions of at least one of the electronic components 10 of the printed circuit board 9 engage. This makes it possible to design the electrical machine 1, which may be designed, for example, as a water pump, an oil pump, or a coolant pump, in a compact and at the same time more powerful way, since the larger electronic components 10 required for the more powerful design can be arranged in the at least one recess 12 of the plastic sheathing 8 in a way that optimizes the installation space. The plastic sheathing 8 also has a supporting contour 13 (see FIG. 3), by means of which the printed circuit board 9 is supported on the plastic sheathing 8. A supporting contour 13 of this kind is also shown and labeled in a similar way in FIG. 12 as the outer retaining ring S013. An annular groove 14 is also provided, in which a housing lid 15 (see FIG. 1) engages with an annular projection 16, thereby positioning the housing lid 15 relative to the plastic sheathing 8 and thus also to the stator 6.

Looking at FIGS. 1, 3, and 4 in particular, a bearing 17 can be seen, in particular a plain bearing, for the rotor 5 is embedded/injected into the plastic sheathing 8. It should, of course, be possible to include “encapsulation” of the bearing 17 with the material of the plastic sheathing 8 under the term “injected”. This offers the major advantage that the bearing 17 can be firmly attached to the plastic sheathing 8 and, via this, also firmly attached to the stator 6, so that a complex assembly of the bearing 17 on the plastic sheathing 8 or on the stator 6 or the housing lid 15 can be dispensed with. This not only saves storage and logistics costs, but also reduces the manufacturing effort required to produce the electrical machine according to the invention. Alternatively, it is also conceivable that the plastic sheathing 8 forms a bearing 17, in particular a plain bearing, for the rotor 5 in a bearing region, i.e., that no separate bearing needs to be provided.

Embedding the bearing 17 in the plastic sheathing 8 allows for a reliable fixation and at the same time precise alignment of the bearing 17 relative to a rotor shaft 18 of the rotor 5, whereby a long-lasting and at the same time smooth-running bearing of the rotor shaft 18 and, in turn, of the rotor 5 can be achieved.

If one looks in particular at FIGS. 4 and 9, it can be seen that lugs 19 with through-openings 20 are arranged on the plastic sheathing 8, by means of which the plastic sheathing 8 and, above it, the stator 6 or the bearing 17 cast therein can be fixed, for example, to a housing 21 of the electrical machine 1.

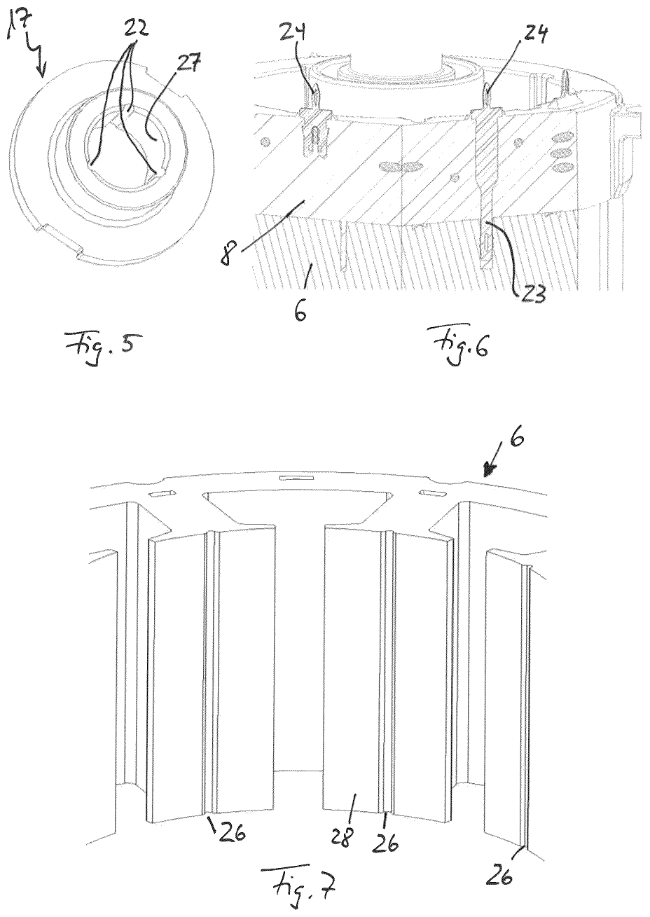

In addition, grooves 22 for the coolant can be arranged on an inner sheathing surface 27 of the bearing 17, whereby the introduction or provision of such grooves 22 at another location can be avoided, as can be seen from FIG. 5.

Furthermore, electrical lines 23 and/or electrical connections 24 can be injected, i.e., embedded, into the plastic sheathing 8, as shown in FIG. 6, so that they are not only reliably fixed in place but also protected at the same time. The term “injected” should of course also cover the “encapsulation” of the electrical cables 23 and/or the electrical connections 24 with the material of the plastic sheathing 8. By embedding the electrical lines 23 or the electrical connections 24 in the plastic of the plastic sheathing 8, a particularly precise alignment of the electrical connections 24 relative to the corresponding connections on the printed circuit board 9 can also be achieved, thus enabling reliable electrical contact.

A space 25 between the recess 12 on the one hand and an electronic component 10 projecting into it on the other can be filled with a filler that is not shown, for example a potting compound or other materials, whereby not only can the vibration resistance of the electrical machine 1 be increased, but also noise damping, whereby both the longevity and the smooth running can be increased. This is done in particular by reducing the volume of air in the space 25 by filling it with the filler.

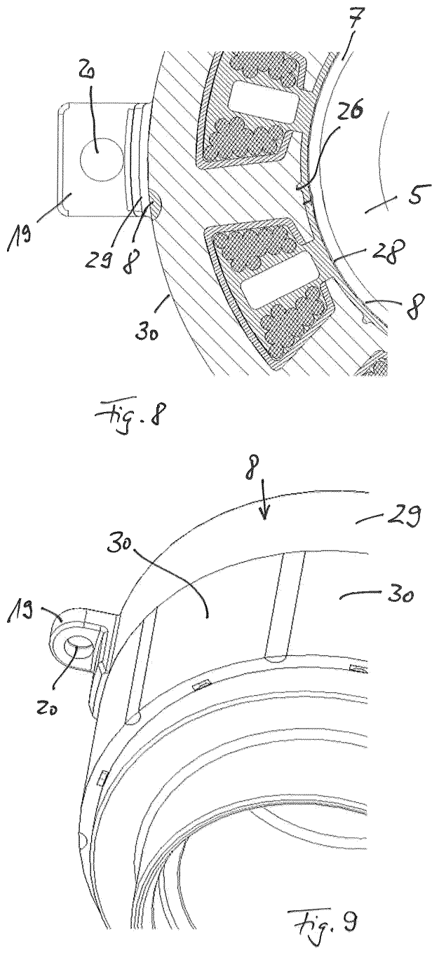

To make it sealed, in particular watertight, the stator 6 is at least partially encapsulated by the plastic sheathing 8, thereby creating a sealed unit. In order to keep a gap, i.e., the annular gap 7, between the rotor 5 on the one hand and the stator 6 on the other hand as small as possible and thus to maximize the efficiency of the electrical machine 1, the inner sheathing surface 28 of the stator 6 facing the annular gap 7 is coated with an extremely thin wall of the plastic sheathing 8. The production of larger and at the same time extremely thin walls without prominent weld seams is extremely complex from a manufacturing point of view, which is why at least one flow groove 26 (compare FIGS. 7 and 8) is arranged on the inner sheathing surface 28 of the stator 6, which is filled with a plastic of the plastic sheathing 8. When injection molding, flow grooves 26 of this kind allow the plastic of the plastic sheathing 8 to be distributed extremely evenly over the inner sheathing surface 28, thereby reliably sealing the stator 6 with respect to the annular gap 7. This also ensures that there are no leaks in the plastic sheathing 8 in the direction of the annular gap 7.

At least one fixing surface 30, which is not encapsulated or covered by the plastic sheathing 8, can be provided on an outer sheathing surface 29 (see in particular FIG. 9) of the stator 6, which in particular serves to fix it in place during encapsulation. The stator 6 must be fixed in the injection mold for overmolding, which is done via the fixing surfaces 30. As a result of the fixing surfaces 30 not covered by the plastic of the plastic sheathing 8, an extremely precise positioning and fixing in a plastic injection molding tool can thus be achieved, whereby the longevity of the electrical machine 1 according to the invention can also be increased.

All in all, the electrical machine 1 according to the invention can be used to provide a particularly compact and powerful pump, which, thanks to the wide variety of designs with, for example, the flow grooves 26, the fixing surfaces 30, the grooves 22 and also the embedded electrical lines 23 or embedded electrical connections 24, ensures an extremely robust and durable electrical machine 1 that can also be manufactured cost-effectively.

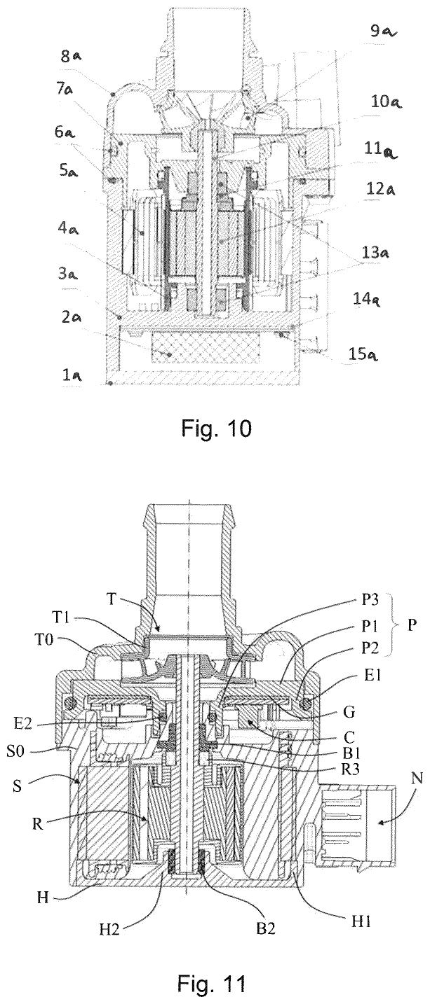

FIG. 10 shows a conventional electronic water pump, which has a cover plate 1a, a control unit 2a, a housing 3a, an insulating sleeve 4a, a stator 5a, a sealing ring 6a, a bearing seat 7a, a spiral housing 8a, an impeller 9a, a rotatable shaft 10a, a thrust bearing 11a, a rotor 12a, a graphite bearing 13a, a heat conducting layer 14a, and a screw 15a.

This electronic water pump has the following disadvantages:
(1) The cooling of the control unit 2a is dependent on separate flow channels for the heat conduction, resulting in a large hydraulic efficiency loss and low heat dissipation efficiency, resulting in low engine power density and large size.
(2) The structure is complex, the axial space utilization is low, and the bearing size is large.
(3) Both the stator 5a and the rotor 12a must be installed with an insulating sleeve for a watertight seal, although there are many other parts, such as sealing rings. The assembly process is complex, the costs are high and the probability of a seal failure is high.
(4) Conventional installation using screws is more expensive.

Furthermore, there are solutions from the state of the art in which the stator 5a or rotor 12a is designed as an injection-molded part, although the degree of integration of the injection-molded parts is low and one or more of the above-mentioned problems remain.

The purpose of the electronic water pump shown in FIGS. 11 through 14 is to overcome or at least improve the disadvantages of the previously described electronic water pump.

FIGS. 11 through 14 show an electronic water pump.

The electronic water pump shown in FIG. 11 includes a stator assembly S, a rotor assembly R, an impeller arrangement T, a control unit C, a heat sink P, a cover plate H, and a connection N.

In the axial direction of the stator assembly S, the impeller arrangement T is arranged at the first end of the stator assembly S (in the following, the end of the stator assembly S from the impeller arrangement T is referred to as the second end) and the control unit C is arranged between the impeller arrangement T and the stator assembly S.

For the purpose of simplifying the description, the following refers to the definitions of the first end and the second end of the stator assembly S; and the end of other components facing in the same direction as the first end of the stator assembly S is referred to as the first end, and the end facing the second end of the stator assembly S is referred to as the second end.

The stator assembly S in FIG. 12 includes a stator core S1, a stator injection molding layer S0, a first bearing B1, and a connection. A recess 12 can also be seen in the stator injection molding layer S0, which can correspond to the plastic sheathing 8, in which at least part of the control unit C (see FIG. 11) or electronic components 10 (see FIGS. 1 through 3) can be accommodated when the electronic water pump is installed.

The connection includes a first connection terminal L1 for connecting the control unit C to the external connection and a second connection terminal L2 for connecting the control unit C to the stator winding.

The stator injection molding layer S0 covers the inner circumference, outer circumference and two axial ends of the stator core S1, forming a sealing structure on the surface of the stator core S1.

The thinnest part of the stator injection molding layer S0 is located at the inner circumference of the stator core S1, and the thickness of the injection molding layer at this part is, for example, 0.4 to 0.8 mm.

In the first end section of the stator assembly S, the stator injection molding layer S0 extends to the inner circumference of the stator core S1 to form a lid-shaped separating structure S01.

The center section of the separating structure S01 penetrates in the axial direction to form a center tube S011.

A first bearing B1 is arranged in the center tube S011. The first bearing, B1, for example, is a friction bearing, in particular a graphite bearing.

The first bearing B1 can be integrally injection molded with the center tube S011 by means of a mold during the formation of the stator injection molding layer S0.

The first bearing B1 is used for the outer circumference of a shaft R2, which is described below.

The stator injection molding layer S0 forms two concentric retaining rings, spaced apart from each other, on the outer circumference of the center tube S011, namely an inner retaining ring S012 and an outer retaining ring S013.

The annular groove formed between the inner retaining ring S012 and the outer retaining ring S013 is used to interact with the heat sink P described below.

The first end of the stator assembly is also equipped with a plug connector, namely a first connection terminal L1 and a second connection terminal L2.

The first connection terminal L1 and the second connection terminal L2 are metal parts.

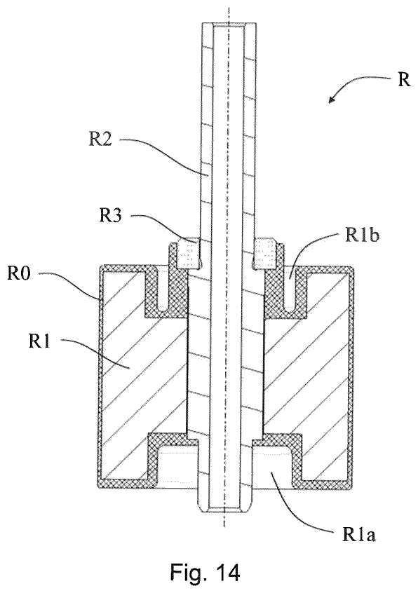

In order to facilitate the installation of the first connection terminal L1 and the second connection terminal L2, the stator injection molding layer S0 is designed with a bayonet-shaped clamping opening S02 at the first end, as shown in FIG. 13,
In the center of the bottom of the clamping opening S02, a guide column S03 is formed that extends to the first end.

It should be understood that in FIG. 13, the second connection terminal L2 is used as an example for description purposes, and that the connection between the first connection terminal L1 and the stator injection molding layer S0 is similar.

In the example of the second connection terminal L2, the second connection terminal L2 includes a first connection end L21 and a second connection end L22. The first connection end L21 is designed as a press-fit structure and is used to plug into the electrical connection socket of the control unit.

The second connection end L22 contains two spaced plug legs.

The distance between the two plug-in legs is greater than the diameter of the lead wire W at the end and decreases gradually towards the first connection end L21 until it is smaller than the diameter of the lead wire W.

This structural design ensures that when the lead wire W is inserted into the two plug-in legs, the outer insulation layer (also called the varnish) of the lead wire W can be destroyed by the plug-in legs, the lead wire W is electrically connected to the plug-in legs and the lead wire W can be clamped by the two plug-in legs, thereby eliminating the need for welding between the lead wire W and the second connection end L22.

The second connection end L22 can be inserted into the clamping opening S02, and the two form an interference fit.

The wire W clamped between the two connector legs is touching the guide pillar S03.

At the second end of the stator assembly S, the stator injection molding layer S0 is designed with an annular groove S04, and the annular groove S04 is used to cooperate with the cover plate H to be described below.

The connection N is provided on the outer circumference of the stator core S1.

The housing of the connection N is also formed in one piece with the stator assembly S during the injection molding process of the stator injection molding layer S0, or in other words, a substructure of the stator injection molding layer S0 also forms the housing of the connector N.

The stator assembly S is attached to the impeller arrangement T at one end.

The impeller assembly T includes an impeller T1 and a spiral casing T0. The Impeller T1 is encased at the first end section of the shaft R2. The impeller T1 from FIG. 11 can correspond to the impeller 2 of the electrical machine 1 from FIG. 1.

The spiral housing T0 is an injection-molded part. Optionally, the material of the spiral housing T0 is the same as the material of the stator injection molding layer S0. The spiral housing T0 covers the first end of the stator assembly S, and the spiral housing T0 and the stator injection molding layer S0 can be connected by fusion welding.

In this embodiment, when the spiral housing T0 and the stator injection molding layer S0 are connected, an edge of the spiral housing T0 surrounds the stator injection molding layer S0.

In addition to the impeller T1, the spiral housing T0 also accommodates the control unit C and the heat sink P.

In the axial direction, the heat sink P is arranged closer to the impeller T1 than the control unit C.

The heat sink P is ring-shaped and comprises a main body ring P1, an outer circumference wall P2 and an inner circumference wall P3.

The outer circumference wall P2 and the inner circumference wall P3 both form flange-like structures extending in the axial direction, so that the cross-section of the heat sink P on one axial side is essentially C-shaped.

The end of the inner circumference wall P3 extends into the annular groove between the inner retaining ring S012 and the outer retaining ring S013, as described above.

The outer circumference wall P2 is adjacent to the end face of the first end of the stator injection molding layer S0.

A first sealing ring E1 is provided between the outer circumference side of the outer circumference wall P2 and the spiral housing T0, and a second sealing ring E2 is provided between the inner side of the inner circumference wall P3 and the center tube S011 of the stator injection molding layer S0.

The above structure allows the separating structure S01 to perform the function of a traditional isolation sleeve, ensuring that the T1 impeller side coolant is isolated from the motor side.

Optionally, the heat sink P consists of a metal material, such as aluminum or an aluminum alloy.

The control unit C is arranged in a semi-enclosed annular space, which is defined by the plate-shaped heat sink P.

A heat conducting layer G is provided between the control unit C and the heat sink P.

To reinforce the fixing of control unit C, control unit C is also fusion-welded to the stator injection molding layer S0 of the stator assembly S.

The stator injection molding layer S0 forms a short column-fixed connection L3 at the first end of the stator assembly S, and the face of the control unit C facing the stator assembly S is designed with a corresponding recess (not shown in the figure). The fixed connection L3 can be inserted into the recess of the control unit C and firmly connected to the control unit C, for example, by hot riveting.

Next, the rotor assembly R is described with reference to FIG. 14.

The rotor assembly R includes a rotor core R1, a shaft R2, a thrust bearing R3, and a rotor injection molding layer R0.

The shaft R2 is attached to the inner circumference of the rotor core R1 in a manner that is fixed against rotation relative to the rotor core R1.

A thrust bearing R3 is provided on the shaft R2. The thrust bearing R3 is located in the axial direction of the rotor assembly R at one end of the rotor core R1 near the first end.

The R0 rotor injection molding layer covers the outer circumference and two axial ends of the R1 rotor core.

Furthermore, at the first end, the rotor injection molding layer R0 surrounds the axial gap between the thrust bearing R3 and the shaft R2. At the second end, the rotor injection molding layer R0 surrounds the axial gap between the rotor core R1 and the shaft R2.

In the present embodiment, both axial ends of the rotor core R1 are partially recessed in the inner circumference region to form a first recess R1a and a second recess R1b.

At the first end, the first recess R1a allows the thrust bearing R3 to extend partially into it.

At the second end section, the second recess R1b allows a second bearing B2 to extend partially underneath the bottom thereof.

This solution reduces the overall axial size of the motor.

Returning to FIG. 11, the cover plate H, when the rotor assembly R is embedded in the stator assembly S and the two are assembled together, is arranged at the second end of the stator assembly S to close the end. The base body of the cover plate H is made of plastic.

Optionally, the cover plate H is made of the same material as the stator injection molding layer S0.

The outer circumference of cover plate H forms an axially extending annular flange H1. The outer diameter of the annular flange H1 is essentially equal to the outer diameter of the annular groove S04 of the stator injection molding layer S0, and the inner diameter of the annular flange H1 is essentially equal to the inner diameter of the annular groove S04.

When the cover plate H is aligned with the stator assembly S, the annular flange H1 extends into the annular groove S04.

When the cover plate H is placed on the second end of the stator assembly S, the annular flange H1 and the stator injection molding layer S0 can be joined by fusion welding.

The center portion of cover plate H on the side facing the stator assembly S is partially raised to form a projection H2, with a second bearing B2 being mounted in the projection H2. The second bearing B2, for example, is a sleeve bearing, in particular a graphite bearing.

The second bearing B2 can be molded integrally with the projection H2 by means of a mold during the injection molding process of the cover plate H.

The present application has at least one of the following advantages:
(ii) Both the rotor assembly and the stator assembly are one-piece injection-molded structures with a simple assembly process and good sealing effect.
(ii) For injection molding of the rotor, the rotor core and thrust bearing are injection molded and sealed in one piece, which reduces the axial length, reduces the number of parts, and saves additional sealing costs. For the injection molding of the stator, the stator, the original housing, the plug, the original insulating sleeve, and the graphite bearing are injection molded as a single piece, eliminating the original insulating sleeve and at the same time making the entire spatial structure more compact and significantly reducing the volume.
(iii) Placing the control unit between the motor and flow channel, with a heat sink and thermal interface material (TIM) in the middle, eliminates the need to add additional heat sinking channels, reduces the loss of fluid efficiency, and provides better cooling of the control unit. This increases the motor power density and reduces the size of the entire water pump.
(iv) The spiral housing and the stator injection molding layer, the stator injection molding layer and the cover plate, and the control unit and the stator assembly are all connected by plastic welding. No screws are needed in the entire pump, which reduces costs.
(v) The stator copper wire is inserted into the injection-molded stator using terminals with mechanically broken enamel, without the need for welding or soldering. The connections and the control unit are connected using press fits, without the need for welding or soldering, which reduces process costs.
(vi) The overall structure is simple and reliable, and the number of sealing rings is reduced from four to two, which greatly reduces the probability of seal failure.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. An electrical machine, comprising:
a rotor rotatable around an axis of rotation,
a stator that is fixed against rotation with respect to the rotor, concentrically surrounding the rotor while forming an annular gap that is confined radially between the rotor and the stator and can have a cooling liquid flowing through it,
wherein the stator is at least partially encapsulated by injection molding with a plastic sheathing,
a printed circuit board with electronic components arranged on the printed circuit board and a central opening through which a rotor shaft of the rotor protrudes,
wherein the plastic sheathing has on a side facing the printed circuit board at least one recess in which at least one electronic component of the printed circuit board engages.

2. The electrical machine according to claim 1, further comprising:
a bearing for the rotor embedded in the plastic sheathing, or
a bearing for the rotor is formed by the plastic sheathing in a bearing region.

3. The electrical machine according to claim 2, wherein grooves for the coolant are arranged on an inner sheathing surface of the bearing.

4. The electrical machine according to claim 1, further comprising electrical connections for making contact with the printed circuit board embedded in the plastic sheathing.

5. The electrical machine according to claim 1, further comprising electrical lines embedded in the plastic sheathing.

6. The electrical machine according to claim 1, wherein a space between the recess and the electronic components is filled with a filler.

7. The electrical machine according to claim 6, wherein the filler is a potting compound.

8. The electrical machine according to claim 1, wherein at least one flow groove is arranged on an inner sheathing surface of the stator, the at least one flow groove is filled with a plastic of the plastic sheathing.

9. The electrical machine according to claim 1, wherein at least one fixing surface without a plastic sheathing is arranged on an outer sheathing surface of the stator.

10. The electrical machine according to claim 1, wherein the electrical machine is designed as a positive displacement pump.

11. The electrical machine according to claim 1, wherein the electrical machine is designed as an impeller pump.

12. The electrical machine according to claim 1, wherein the electrical machine is designed as an oil pump, a water pump or a coolant pump.

13. A pump, comprising:
a rotor rotatable around an axis of rotation,
a stator that is fixed against rotation with respect to the rotor, concentrically surrounding the rotor while forming an annular gap that is confined radially between the rotor and the stator and can have a cooling liquid flowing through it,
wherein the stator is at least partially encapsulated by injection molding with a plastic sheathing,
a printed circuit board with electronic components arranged on the printed circuit board and a central opening through which a rotor shaft of the rotor protrudes,
wherein the plastic sheathing has on a side facing the printed circuit board at least one recess in which at least one electronic component of the printed circuit board engages.

14. The pump according to claim 13, further comprising a bearing for the rotor embedded in the plastic sheathing.

15. The pump according to claim 13, wherein the plastic sheathing forms a bearing for the rotor in a bearing region,

16. The pump according to claim 13, further comprising electrical connections for making contact with the printed circuit board embedded in the plastic sheathing.

17. The pump according to claim 13, further comprising electrical lines embedded in the plastic sheathing.

18. The pump according to claim 13, wherein a space between the recess and the electronic components is filled with a filler.

19. The pump according to claim 13, wherein at least one flow groove is arranged on an inner sheathing surface of the stator, the at least one flow groove is filled with a plastic of the plastic sheathing.

20. The pump according to claim 13, wherein at least one fixing surface without a plastic sheathing is arranged on an outer sheathing surface of the stator.
